(19) United States
(12) Patent Application Publication
(10) Pub. No.: US 2007/0029239 A1
(43) Pub. Date: Feb. 8, 2007

(54) External filter

(76) Inventor: Janusz Marek Jankiewicz, Warsaw (PL)

Correspondence Address: James Faier;Faier & Faier, 566 West Adams Street # 600, Chicago, IL, 60661, US

(21) Appl. No.: 10/555,986

(22) PCT Filed: May 5, 2004
(86) PCT No.: PCT/PL04/00033

§ 371 Date: Oct. 16, 2006

(30) Foreign Application Priority Data
May 8, 2003 (PL) P-360008

(51) Int. Cl. A01K 63/04

(52) U.S. Cl. 210/167.21

(57) ABSTRACT

External filter for filtering fluids, especially water in aquarium, is composed of a filter container, a filtering packs, a cover unit, an engine unit together with a rotor and a working chamber with a piston unit and a non-return valve. Between the working chamber (22) with the piston unit (17) and the inflow conduits of fluid circulation is situated durably separately fastened, preferably rotationally, the control unit (9) with the controlling element (1) assembled movably towards the control unit (9) having a fluid inflow hole (6), a fluid outflow hole (2) and a hole of pumping cycle (4). Reciprocal position of fluid inflow hole (6) and fluid outflow hole (2) corresponds to the inflow terminal (11) outflow terminal (12) of fluid distribution situated in the control unit (9) and between working chamber (22) and hole of pumping cycle (4) the control valve (3) is situated.

The invention relates to an external filter for filtering fluids, especially water in aquarium.

External filters which for their start-up have to be previously “manually” primed with fluid are well-known. Switching-on the pump engine is not possible until “manual” filling of these systems with fluid is done by the user. The filters of such kind are relatively defective because they have to be additionally serviced before their setting up in motion, namely they have to be filled with fluid, and, moreover, they may eventually cause to spill over the user's clothes or to flood a room.

There are also well-known the external filters equipped with mechanisms enabling their filling with fluids, wherein their “manual” priming by user is not necessary. By means of these mechanisms, user fills the system and its supply conduits with fluid, and then sets up a pump in motion. Three types of the pump mechanisms are known. According to the first type, the system may be primed by small manual pump by means of which fluid may be pumped into the system. The small pump is placed on the filter cover and has its movable part with vertical handle. The user is able to pump fluid to the filter by pushing in and drawing out the movable part of the small pump. The small pump is assembled on the way of fluid between a fluid tank and a filter chamber, so that upper inflow to the pump is lower than the highest position of a pump piston and lower inflow is higher than the lowest piston position. Such type of pump design enables to suck in fluid to a tank by pushing the piston from its highest position to the lowest one—by means of externally protruding handle. Suitable placing of lower outflow hole from the pump that is higher than the lowest piston position, enables a fluid to flow into the filter chamber. Then, by pulling up the handle, the piston will be placed to its highest position again, and the cycle will be repeated. This way, the system will be primed. Next, the system is put in motion. This kind of filters—with small manual pump additionally assembled—enabling the pumping of fluid from a tank into the system, in no way counteracts a fluid to come back into a tank and air into filter chamber. It is the result of the lack of non-return valves (there is one valve only)—fluid, therefore, having been sucked into the system by means of manual small pump, comes back to the tank. Fluid oscillates between the tank and the system, and air comes back to the system all the time.

The second essential mechanism that enables to prime the system without “manual” user's operations is based on pushing out air from a pumping part and sucking in, on its place, fluid from its tank. In the cover of the system is placed “the piston” of the diameter that enables the user to place his palm. Action of “this piston” has 2 cycles: during the first cycle the user pushes “the piston” pushing it into filter cover and causing pushing out air from the system and from its inflow conduits, during second cycle—when the user takes off his palm from “the piston” that comes back to its initial position by the action of assembled spring, fluid is being sucked up from its tank. It happens so, owing to the non-return ball valve closing the conduit through which air has been pushed out, and counteracting air coming back to the filter chamber. This way, the priming of the system with fluid inflowing under the force of gravity is reached. Next, the system is ready to be put in motion. Such kind of filter construction is also defective. Indeed, owing to the non-return valve applied, the filter is able to push out air from pumping element, and then to suck up fluid from its tank, but there is necessary to suck up fluid effectively and to prime the pumping part, both functions during one cycle, that is, by means of one pushing and releasing “the piston”. It is so, because during the second cycle the underpressure in the tank is equal to the pressure in the filter chamber grown by pushing the piston. It results that repeated sucking up of fluid from its tank to the pumping part is impossible. Relating to that, fluid doesn't flow from its tank to the system. It exists, therefore, the necessity of reaching the effect of filter priming during the first cycle, what in consequence forces to apply the inflow conduits of smaller diameter—to have less air to be pushed out during the first cycle, and less fluid to be sucked up for priming the filter. All these elements determine decreasing of the capacity of such filters and therefore stronger engines have to be applied what in consequence increases current consumption.

The third mechanism enabling to prime the system, wherein doing it “manually” by user becomes unnecessary, is composed of working chamber in which filter rotor is assembled and to which an access exists through the hole which may be open and closed in the filter cover. The conduits connecting the filter and fluid tank, as well as the conduit connecting working chamber and filter chamber are also connected to the working chamber. In order to prime filter chamber, working chamber is flooded with small quantity of water through the hole in cover, and the system is set up in motion. Poured fluid circulates in working chamber making possible sucking out air from filter chamber through the conduit connecting working and filter chambers and by pushing fluid out through outflow hole outside the system. In place of air pushed out through the second inflow conduit, connecting fluid tank and filter chamber, fluid is sucked in, what results in priming the system. Such filters have the defect that “manual” pouring of some quantity of fluid to working chamber is necessary. However, “manual” priming of all system is not necessary, but some additional service before setting up in motion the system has to be done, and the effectiveness of so primed system is not sufficient. Moreover, without pouring some quantity of fluid into working chamber, the system will not function at all, because the sucking up air from filter chamber and priming the system would be impossible.

During exploitation of filters other trouble arises when disconnecting the filters from conduits supplying fluid is required, e.g. when cleaning the filter or exchanging the filtering packs are needed. Disassembling of conduits from water feeding heads of the filter is connected with spilling over the user's clothes and with flooding the room with some quantity of water. Some solutions of cutting off water supply assembled on water circulation coil pipes are known. The problem could be solved either by assembling additional clamps on coil pipes or by installing the elements blocking water inflow on the unit of coil pipes terminals.

It has been stated unexpectedly, that all these defects of the background of the invention might be avoided owing to the control unit, being set up in three positions and, depending on the set up position, making possible to disconnect the control unit from the system, to pump out air from the filter chamber, to pump fluid and to filter it. External filter composed of filter container, filtering packs, cover assembly, engine assembly together with a rotor, and working chamber together with a piston unit and non-return valve, is characterized by the fact that between working chamber with piston unit and external conduits of fluid circulation is situated durably separably fixed, preferable rotationally, control unit with assembled controlling element being movable towards control unit. Controlling element has an inflow hole for fluid, an outflow hole for fluid and a hole of pumping cycle, whereas reciprocal position of fluid inflow hole and fluid outflow hole correspond to the arrangements of fluid supply and fluid draining placed within control unit. Between working chamber and the hole of pumping cycle a control non-return valve is situated. Controlling element may be of plate, cylinder or cone shapes as well as of other body shapes.

Pumping out air is realized by piston motions up and down, and only when the process is finished and suitable underpressure in filter chamber is generated, priming the system with fluid occurs. Fluid pumping out is realized by piston motions up and down, whereas these motions may be realized as linear, spiral or as other optional motion. Control unit may be assembled in piston unit or outside of it.

If control unit is assembled within piston unit, it is characterized by its ability of rotation towards the piston unit, within which the control unit is fixed, and controlling element fixed within control unit is immovable towards the piston unit. The three positions mentioned are to be reached by rotating a movable part of the control unit towards immovable controlling element and, at the same time, towards the piston unit.

First position of control unit arrangement towards controlling element makes possible to take out the control unit from the system. It is right, when disassembling the control mechanism is possible owing to suitable external notch in external surface of the control unit, within which corresponding internal protrusion in internal surface of the piston unit enters at this position only. At first position, setting up of the control unit towards controlling element is of such kind, that outflow terminal of the control unit is in line with fragment without passage of controlling element, and an inflow terminal of the control unit is in line with the fragment without passage of controlling element, what counteracts flowing out fluid from inflow conduits connected to inflow and outflow terminals of the control unit. It is preferable when the first position is set up by turning home the control unit clockwise towards “the handle” of the piston unit.

The third position makes possible to pump out air from the system. It is preferable when this position is set up by turning home the control unit counter-clockwise towards “the handle” of the piston unit. At this position the control unit is set up towards controlling element in the way, that outflow terminal of the control unit is in line with the hole of pumping cycle equipped with control non-return valve, and second inflow terminal is in line with the part of controlling element without passage, and, owing to that, only one way remains open to the filter chamber. This way conducts through working chamber which is closed from one side by control valve mentioned above, and from other side by means of cover valve. At this position, control valve and cover valve make possible to pump out air from the filter chamber. Air leaves the filter chamber through working chamber. Working chamber is situated between filter chamber (situated within filter container) being connected to it by means of cover valve (situated in lower part of cover unit) and outflow terminal of control unit, from which it is separated by control valve of controlling element. It is preferable when piston unit is screwed within cover unit owing to external thread in external cylindrical surface of the piston unit, and corresponding to it internal thread in internal cylindrical surface of the cover unit. Owing to such connection of piston and cover units, a screwing motions up and down of piston unit is possible together with control unit towards cover unit by turning “handle” of piston unit. Owing to the motion up of piston unit towards cover unit, the volume of working chamber increases and air sucking up occurs from filter chamber to working chamber through cover valve. During this motion cover valve between filter chamber and working chamber is open and control valve between working chamber and outflow terminal is closed. Then, as a result of motion down of piston unit, the volume of working chamber decreases and pressing air is pressed outside from working chamber through control valve and further through outflow terminal of control unit. During this motion cover valve between working chamber and filter chamber is closed, and control valve between working chamber and outflow terminal is open. During first part of the cycle, that means, during lifting up piston unit, underpressure in working chamber occurs, that sucks up air from filter chamber. During second part of the cycle—at the motion down of piston unit, owing to the decrease of the volume of working chamber, air is pushed outside. It is preferable when next, by successive turning with handle of piston unit that forces the motion up of piston unit towards cover unit, successive volume of air is sucked up from filter chamber to working chamber and this way begins successive cycle of pumping out air from filter chamber. It is right, when the cycle is repeated until suitable underpressure in filter chamber is reached, in other words, till enough air is pumped out, after the control is set up towards piston unit at second position called working one, the underpressure could suck up fluid from external fluid tank and could prime filter chamber. At second position—called working one, control unit is set up parallel to “the handle” of piston unit. At this position, control unit is set up towards controlling element this way, that the inflow terminal of control unit is in line with inflow hole of controlling element conducting directly to working chamber, and outflow terminal of control unit is in line with outflow hole of controlling element conducting from working chamber. At second position—working one, an underpressure produced at third position in filter chamber sucks up from the tank the fluid that flows into filter chamber through inflow terminal of control unit, then through inflow hole of controlling element and through the inflow to a container, getting this way the system to be primed. After this priming the system, the engine with its rotor is set up in motion. The rotor pumps fluid from filter chamber to working chamber and further through outflow hole in controlling element and outside through the outflow terminal of the control unit. Second position—working one is set up during all working cycle of the system.

It is preferable when control unit has a hand grip and external groove in external surface of control unit for turning it in piston unit, and when piston unit has suitable handle to turn piston unit in cover unit. It is right. when cover unit is connected motionless with filter container by means of snap fasteners connecting cover unit with filter container.

Controlling element may be fastened by means of hole that fastens it to movable part of control unit, then the change of position of controlling element towards control unit is realized by turning. If controlling element has shape of a plate, this motion may be realized by stroke.

It is preferable when piston unit is equipped with deaerating valve making possible, at the working phase, to conduct outside air that has been accumulated in filter chamber, as a result of releasing it from pumped fluid, and, at the priming filter chamber phase, to press out air from the highest parts of filter chamber that were not involved by the functioning of the valve of cover unit. Function of the valve of cover unit is limited by the fact that it is not placed at the top of filter chamber, and when water is flooding the filter chamber, at some moment it floods the valve of cover unit. Then, air collected above this valve is not able to get out of filter chamber and forms an air cushion. Then, it is right when cover unit is equipped with small chimney making possible to conduct out air from the top part of the filter chamber to deaerating valve and further outside the system through deaerating hole of cover unit, and then through corresponding deaerating hole of piston unit.

Alternatively, control unit may also be separated from piston unit and fastened in a cover. Then, after having set up the first, the second, and the third positions of control unit towards controlling element, the control unit doesn't move together with the movement of piston unit. Separate working chamber of pumping unit is then connected with the hole of pumping cycle of controlling element by intermediary of a connector and control non-return valve, that may be assembled either in the hole of pumping cycle or between this hole and working chamber.

This alternative solution of external filter with controlling element and working chamber has exactly the same control unit as described above, that is also to be set up at three positions. The first position makes possible disconnecting control unit together with its inflow conduits from the filter without outflow of fluid from them, the third position makes possible to pump out air from filter chamber and to generate within it an underpressure, that, at second position called working one, will suck up fluid from its tank to filter chamber, the second position makes possible, first, to suck up fluid from its tank to filter chamber and then, after having started up the engine with a rotor, to pump fluid and to filter it. This time, however, control unit has been fastened to the socket of control unit in external surface of a cover. The first position is to be set up by turning home clockwise the control unit in the socket of control unit, the third position by turning home anti-clockwise, and the second position is to be reached by setting up control unit in the middle, symmetrically between the positions first and third.

At the first position, the movable part of control unit is set up towards controlling element exactly in the same way as in former constructional solution and a whole process runs exactly as in case of former solution.

At the third position the movable part of control unit is set up towards controlling element exactly in the same way as in former constructional solution. This time, separate pump has been constructed, connected with controlling element by means of a connector. At first phase of the cycle of pumping out air from filter chamber, the air is sucked up by the piston moving up in separate pump. Then air comes through non-return valve of the pump into working chamber situated within the pump. At this phase of the cycle the control valve in control element is closed, owing to that, air from outside is not able to get inside working chamber through a connector. At second phase of the cycle of pumping out air from filter chamber, the piston moving down the pump presses air outside the system, through a connector and further through being open at this phase of the cycle control valve of controlling element. At this phase, pump valve separating working chamber from filter chamber is closed. Next, successive cycle begins and it consists of the phase of air sucking up from filter chamber to working chamber and then of the phase of air pressing outside working chamber. So many of full cycles of pumping out air from filter chamber are to be done, till suitable underpressure within filter chamber is reached, being able to suck up fluid from external fluid tank after the control unit have been set up into second position, called working one.

At second position the movable part of control unit is set up towards controlling element exactly in the same way as in case of former constructional solution. Just as before, at the moment of setting up the control unit at second position, the underpressure in filter chamber sucks up fluid from external fluid tank, priming the filter chamber. After this priming, a rotor is set up in motion and the filtering of fluid begins. The difference lies in the fact, that this time, fluid doesn't flow through working chamber as it was in former solution. It flows directly into filter chamber, flowing through control unit then through cover inflow and hermetically connected to it the chimney with passage, constituting a part of the bottom separating the filter chamber from an engine, a pump, and a connector. Next, after priming filter chamber and switching on the rotor, fluid is sucked up by the rotor situated in rotor chamber placed in lower surface of a bottom. The rotor pushes it through outflow chimney of a bottom connected hermetically with cover outflow and further through control unit outside the system to fluid tank.

Owing to such filter construction according to the invention, all defects of the background of the invention mentioned above were fortunately amended, and unexpected result of priming the system during any number of cycles was obtained, and, at the same time, high capacity of the system was kept.

The invention presented possesses an advantage when comparing to the filters primed “manually”, owing to the fact, that it doesn't require executing additional functions mentioned above, before setting up the system in motion, and it creates no possibility of spilling over the user's clothes. Additional advantage of the invention is the possibility of such setting up of the control unit of the system, that it counteracts flowing out fluid from the inflow conduits after disconnecting them from the system.

The defect of the background of the invention lying in returning fluid to its tank and in simultaneous remaining of air in a pumping part of the system is to be solved by the invention described below, by means of the application of non-return valves. The invention presents adjustable control unit that may be set up in the position making possible pumping out air from the system. Non-return valves described above counteract any return of air.

The defect of the background of the invention lying in the necessity of the system priming during one cycle has been solved by the controlling element already mentioned, and by the mechanisms described above making possible pumping out air during larger number of cycles. Owing to this effect, the possibility of application of the inflow conduits of larger diameter is obtained—what increases a capacity of the system. It is an essential advantage from the point of view of the user. Moreover, there is no fear, that if the mechanism of priming the pump doesn't function during the first cycle, the functions of priming and setting up in motion the system are effectively not possible. This filter makes possible to prime the pump during any number of cycles.

The defect of the background of the invention lying in the necessity of priming the working chamber with some quantity of fluid in order to pump out fluid from the system is solved by the filter described below owing to the application of at least two non-return valves. They make possible to pump out air from the system and to suck in fluid.

The subject of the invention has been described by the examples shown in figures, where

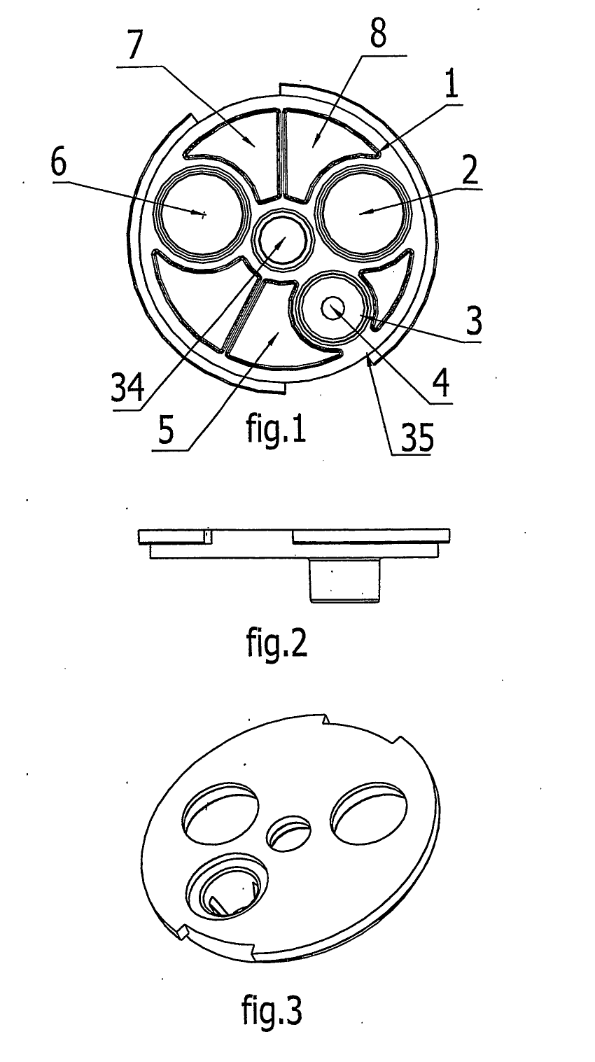

FIG. 1 presents projection of controlling element from below, illustrating the distribution of holes,

FIG. 2 projection of side-view of controlling element,

FIG. 3 perspective view of controlling element,

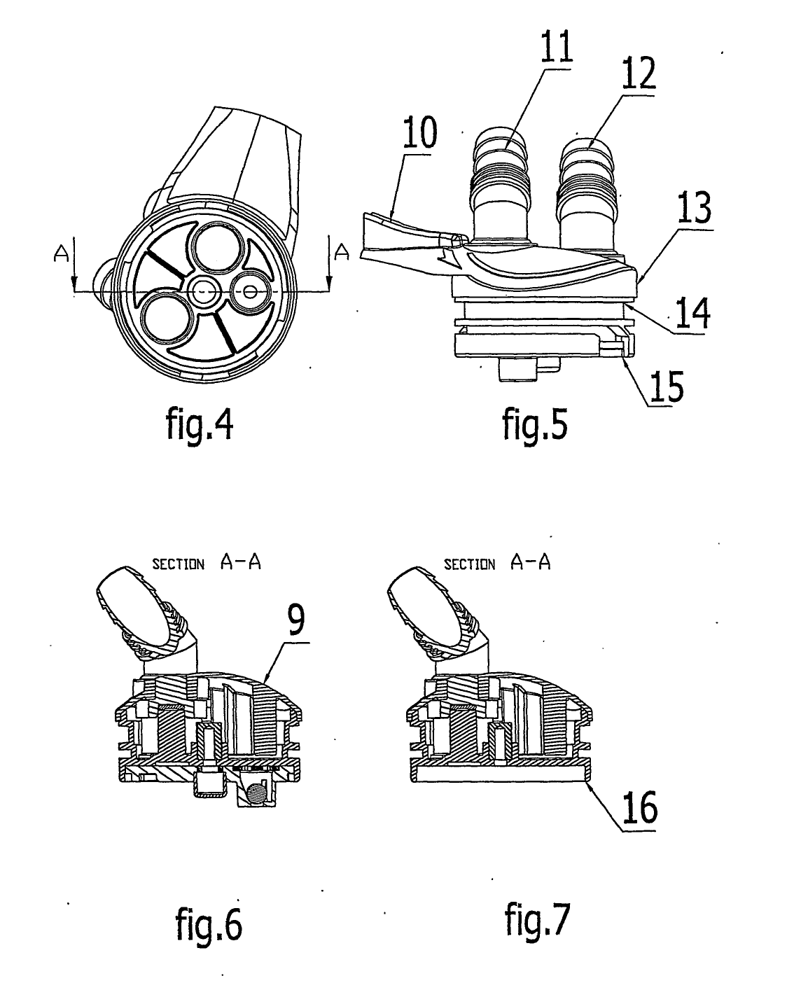

FIG. 4 presents projection of control unit from below with visible controlling element and with section A-A marked,

FIG. 5 presents side-view projection of control unit with visible outflow terminals and notched external cylindrical surface of control unit, making possible assembling of control unit within piston unit,

FIG. 6 presents section A-A across control unit, presenting connections of particular elements of control unit,

FIG. 7 presents section A-A across control unit, presenting movable part of control unit without controlling element,

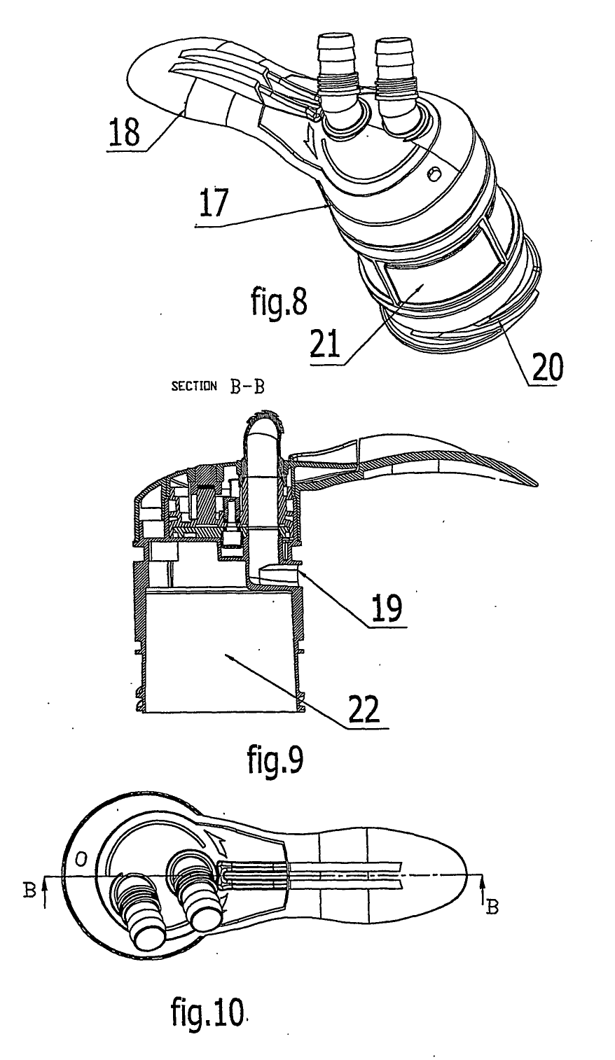

FIG. 8 presents perspective projection of piston unit where the control unit assembled is to be observed being set up in working position (described in the invention essence) it means, in the position where the hand grip of control unit is in line with the handle of piston unit,

FIG. 9 presents section B-B across piston unit and control unit assembled within it, where it is shown the way of fastening control unit in cover unit,

FIG. 10 presents projection from above on piston with section B-B marked, together with control unit set up in working position,

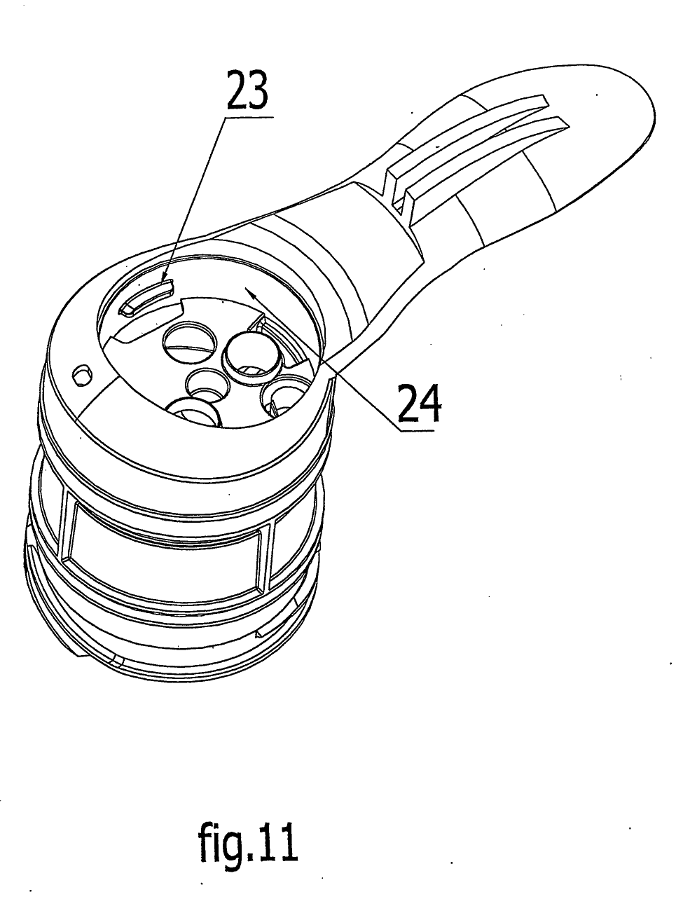

FIG.11 presents piston unit with control unit disassembled from it, and illustrates the way of fastening control unit within piston unit,

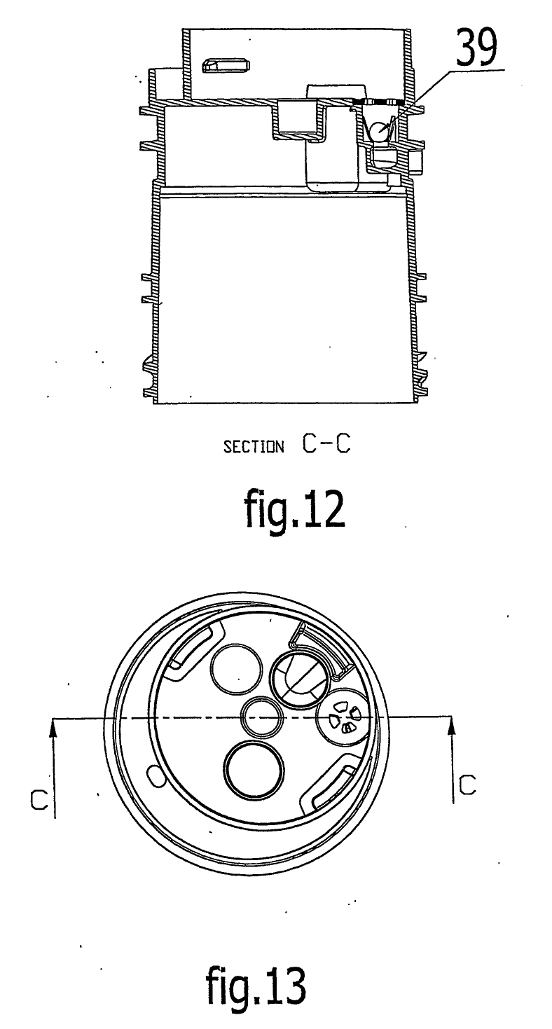

FIG. 12 presents section C-C across piston unit presenting deaerating valve,

FIG. 13 presents projection from above of piston unit with section C-C marked,

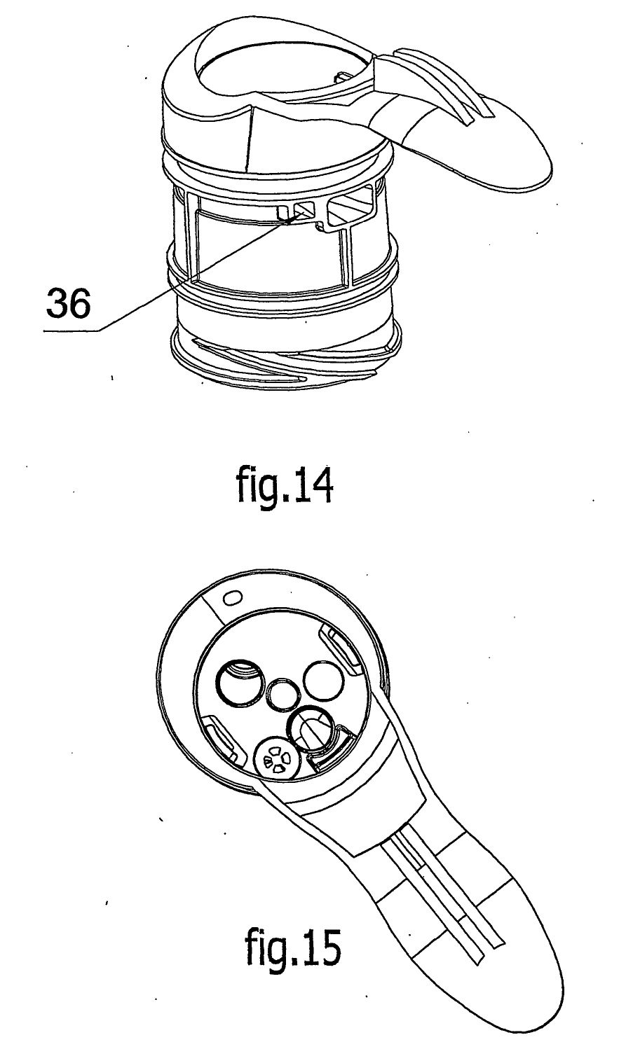

FIG. 14 presents perspective projection of piston unit with visible piston deaerating hole,

FIG. 15 presents projection from above of piston unit with visible hand grip of piston unit and holes corresponding to the holes of control unit and with deaerating valve,

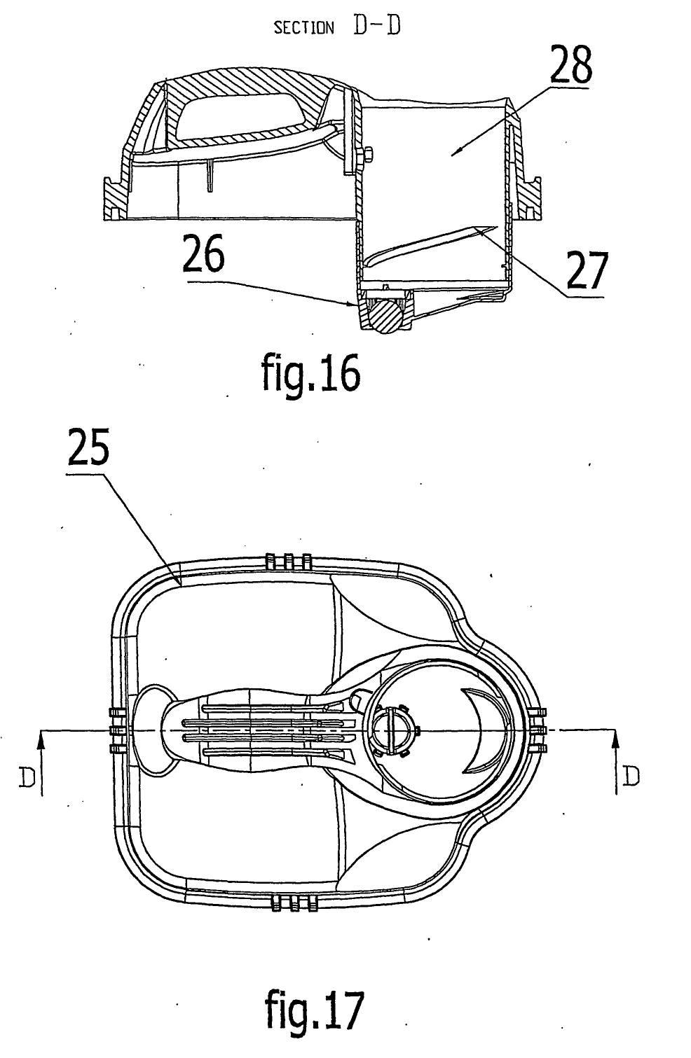

FIG. 16 presents section C-C across cover unit with visible thread making possible fastening control unit together with piston unit in cover unit and with visible non-return valve in bottom part of cover unit and valve ball assembled within it,

FIG. 17 presents projection from above of cover unit with section C-C marked, visible place of application of the handle of piston unit and non-return valve to lower part of cover unit,

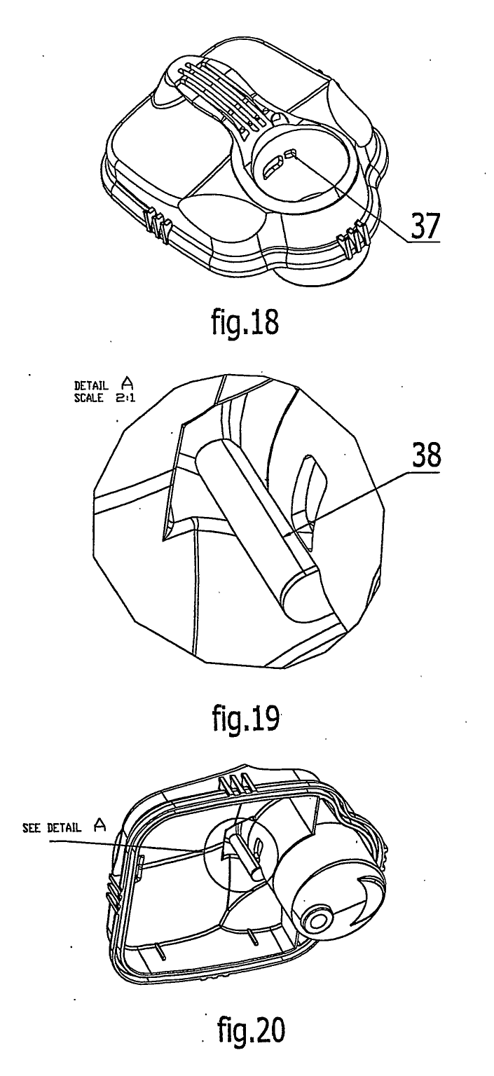

FIG. 18 presents perspective projection of cover unit with visible deaerating notch of the cover,

FIG. 19 presents enlargement of deaerating chimney of cover unit,

FIG. 20 presents perspective lower projection with visible deaerating chimney of cover unit and inflow notch in filter chamber,

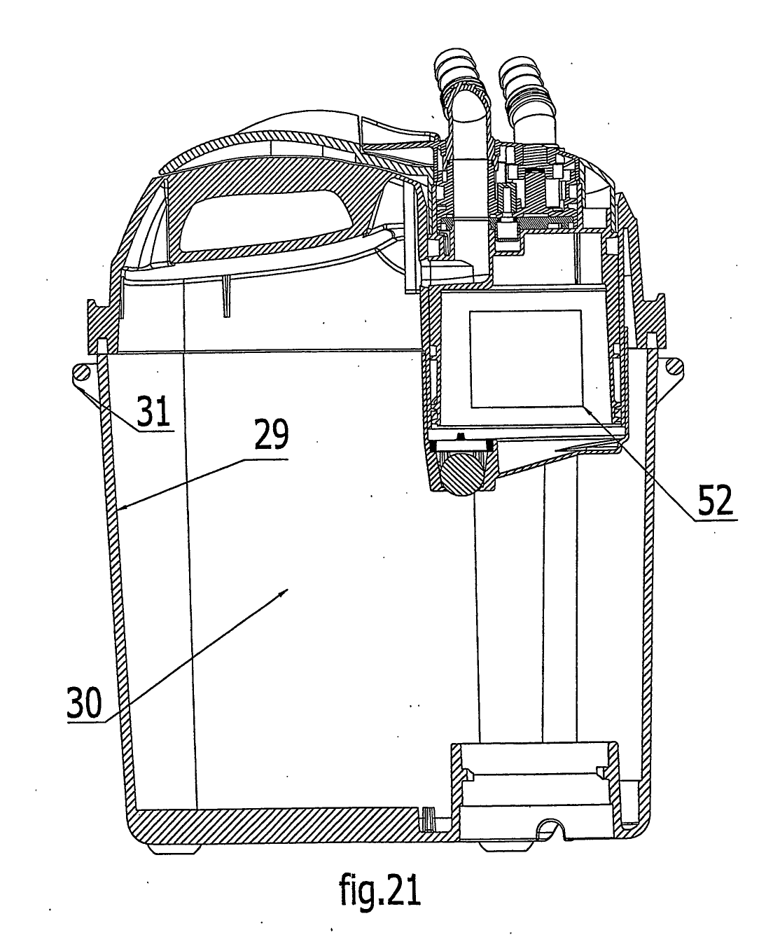

FIG. 21 presents filter unit with cover unit, piston unit, and control unit assembled within it and illustrates filter chamber and the way of fastening cover unit together with the units in filter unit assembled within it,

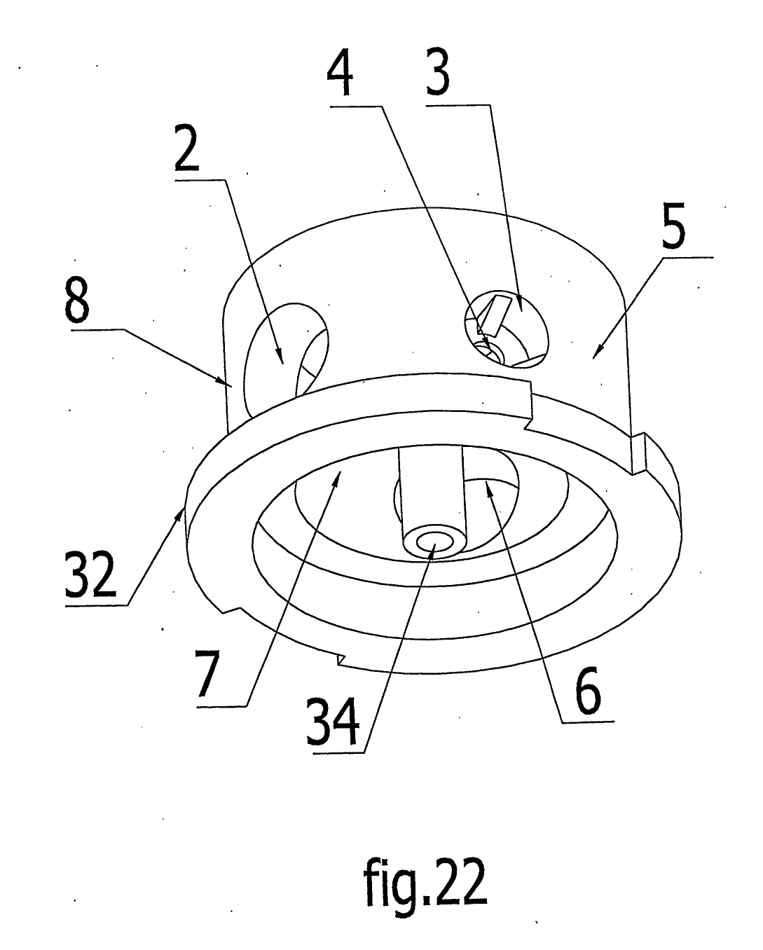

FIG. 22 presents alternative solution of controlling element in the shape of a sleeve,

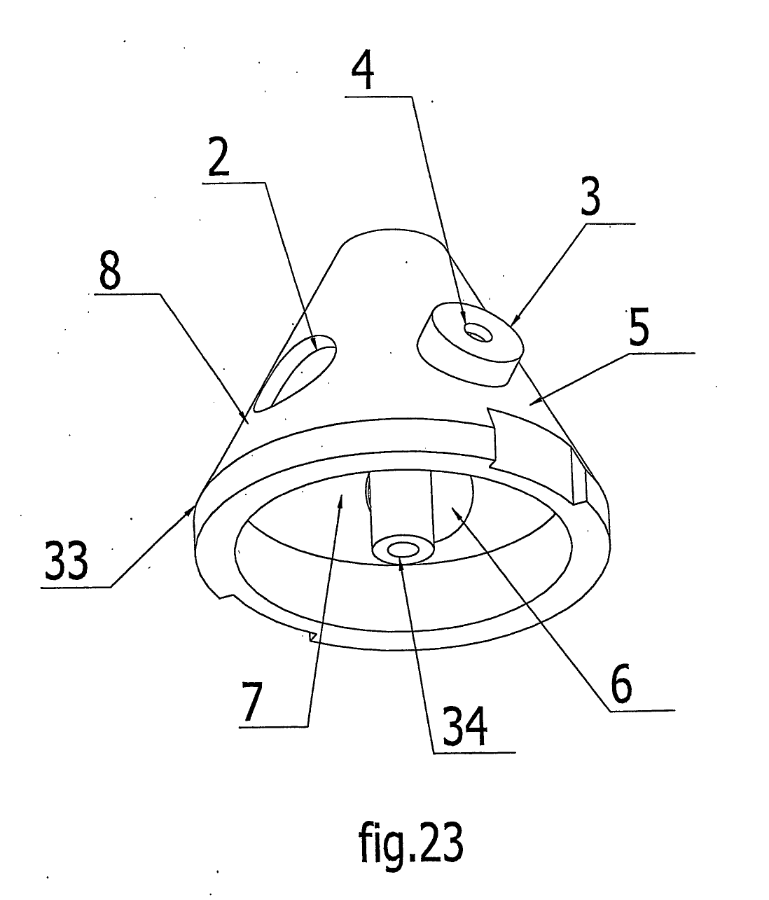

FIG. 23 presents alternative solution of controlling element in the shape of a cone,

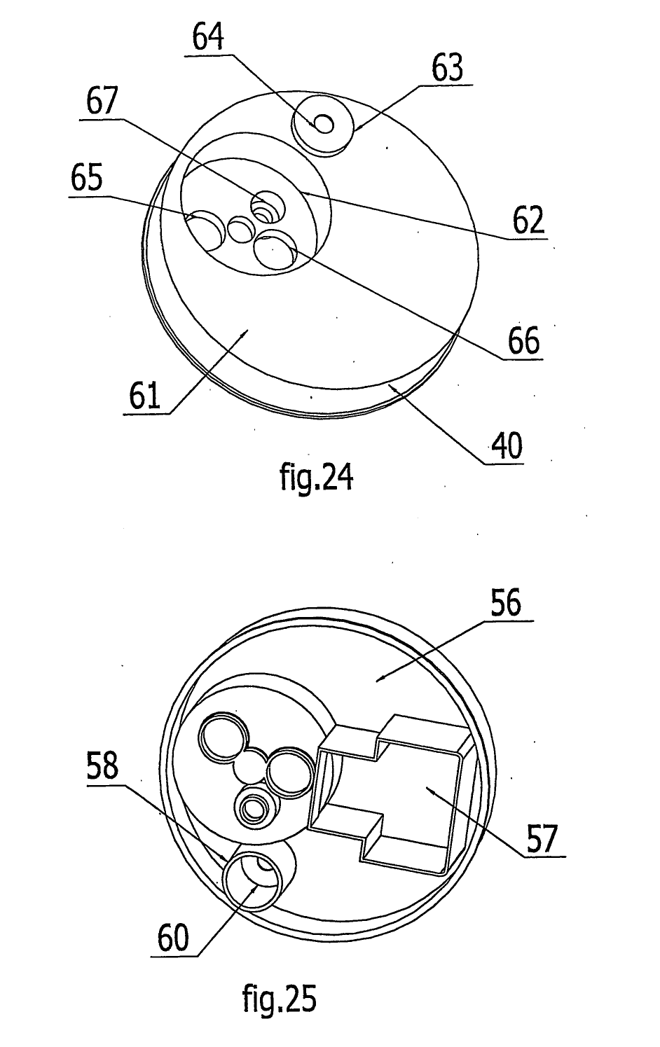

FIG. 24 presents perspective projection from above of the cover of filter alternative solution,

FIG. 25 presents perspective lower projection of the cover of filter alternative solution,

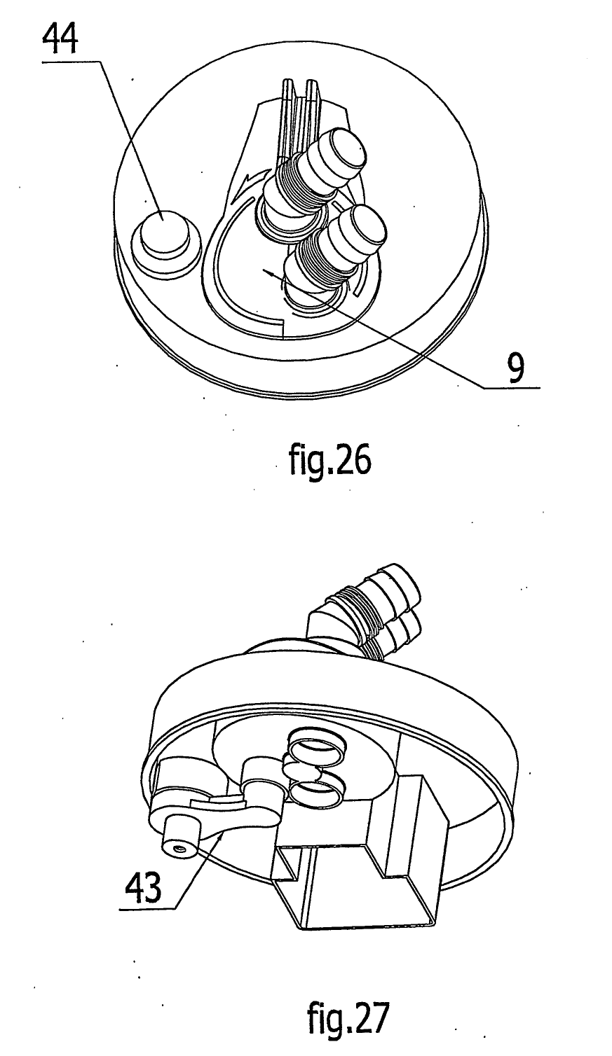

FIG. 26 presents perspective above projection of the cover with control unit assembled and the pump of filter alternative solution,

FIG. 27 presents perspective lower projection with visible connector between control unit and the pump of filter alternative solution,

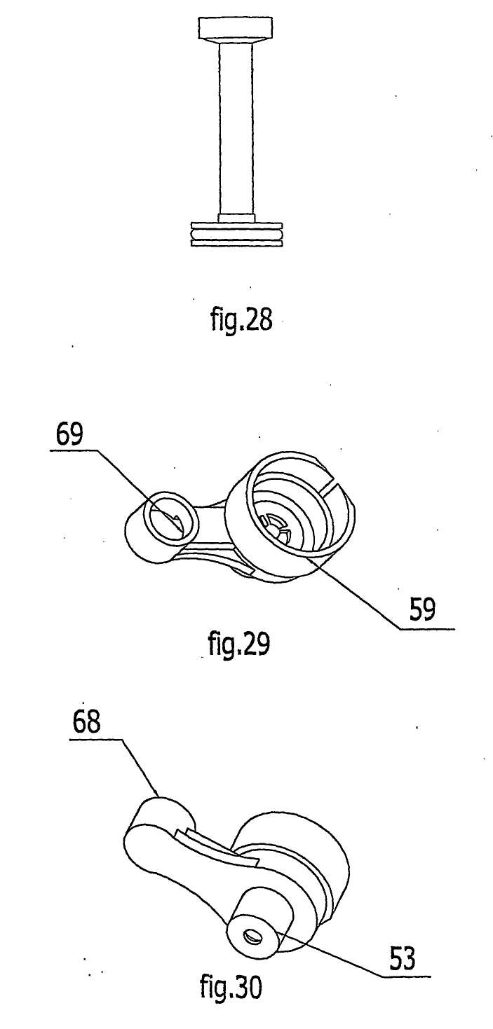

FIG. 28 presents small piston of the pump of filter alternative solution,

FIG. 29 presents perspective projection of a connector,

FIG. 30 presents perspective lower projection of connector with visible non-return valve,

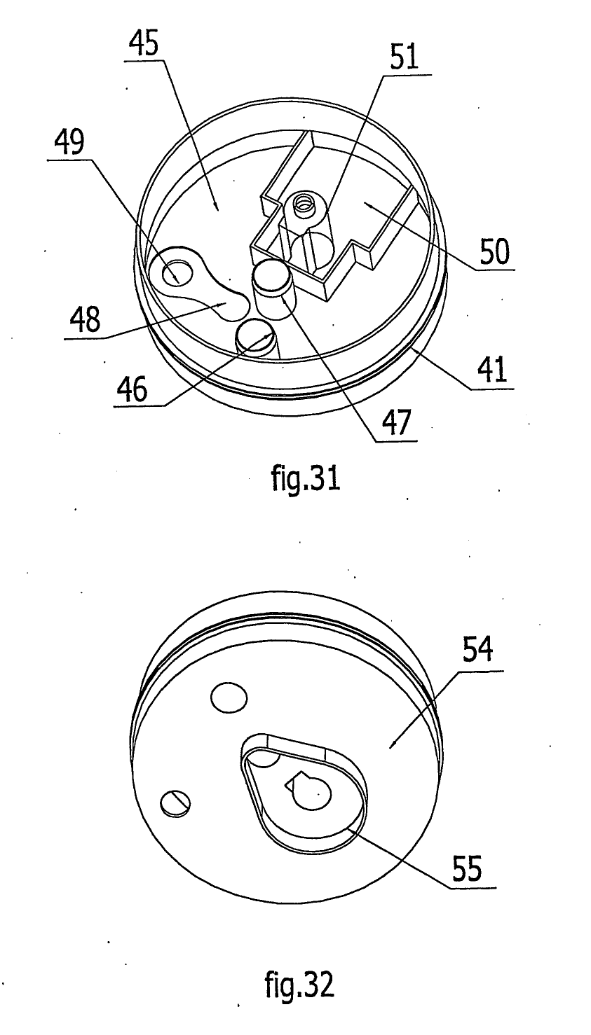

FIG. 31 presents perspective above projection of the bottom of filter alternative solution,

FIG. 32 presents lower perspective projection of the bottom with visible rotor chamber,

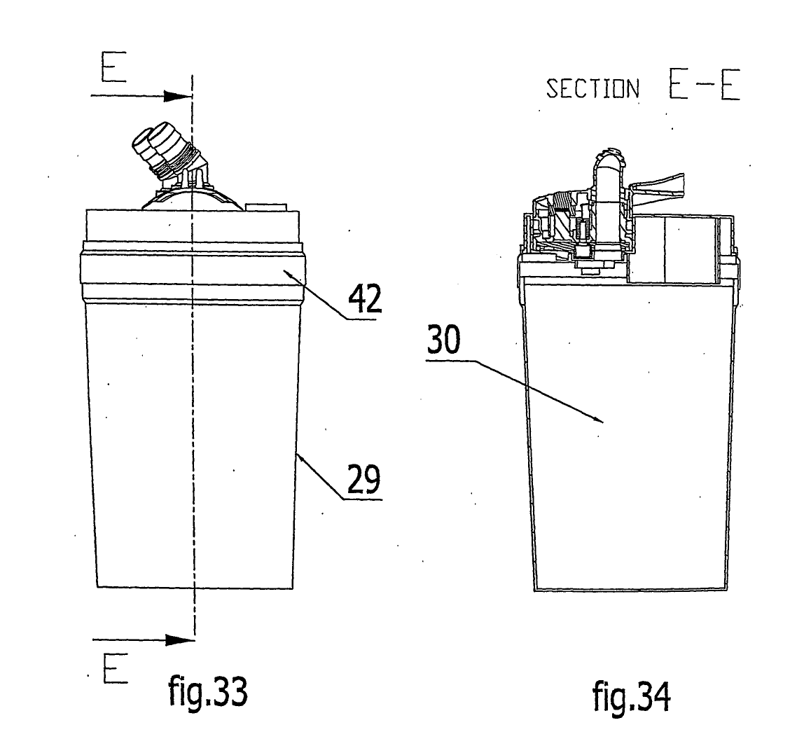

FIG. 33 presents side-view projection of filter alternative solution with section E-E marked,

FIG. 34 presents section E-E across filter alternative solution.

### EXAMPLE 1

In the controlling element 1 to be observed in FIG. 1 in a shape of the plate, is situated outflow hole 2, through which fluid leaves a filter during working phase, inflow hole 6, through which fluid inflows into filter chamber 30 during working phase, control valve 3 together with the hole of control socket 4, through which during air pumping out phase from filter chamber 30, air leaves the system, fastening hole 34 making possible fastening controlling element 1 to movable part 16 of control unit 9, an inflow fragment 5 without passage, which is in line with inflow terminal 11 during disassembling control unit 9 from piston unit 17, what counteracts outflowing of water from inflow conduit, an outflow fragment 8 without passage, which is in line with outflow terminal 12 during disassembling control unit from piston unit 17, what counteracts outflowing of water from inflow conduit, part 7 without passage, which is in line with inflow terminal 11 during the phase of air pump out, what counteracts inflow of fluid into filter chamber 30 and makes possible to pump out air from it. Controlling element 1 is fastened to movable part 16 of the control unit 9 and of piston unit 17 this way that it is immovable towards piston unit 17 and movable part 16 of the control unit 9 may turn towards the axis of fastening hole 34 of controlling element 1. Controlling element 1 and movable part 16 compose control unit 9. Inflow terminal 11 and outflow one 12 also compose the unit, making possible suitable inflow and outflow of fluid from the system during working phase or pumping out air from filter chamber 30 during the phase of pumping out air, hand grip 10, to be held when control unit 9 is set up in three different positions towards piston unit 17 (the first—for disassembling, the second—for working, the third—for pumping out air). In movable part 16 of control unit 9 external notch 15 is situated, and in controlling element 1 is situated control notch 35. With these notches is in line internal protrusion 23 situated in internal surface 24 of piston unit 17 making possible fastening by turning control unit 9 in piston unit 17. In external surface 13 of piston unit 17 is also situated external groove 14 making possible tightening of control unit 9 after having assembled it in piston unit 17.

The handle 18 also composes piston unit 17 making possible (owing to external thread 20 on external cylindrical surface 21 of piston unit 17 and corresponding to it internal thread on internal cylindrical surface 28 of cover unit 25) turning and lifting up piston unit 17 towards cover unit 25 and, this way, increasing volume of working chamber 22. In external cylindrical surface 21 of piston unit 17 is situated an inflow 19, making possible during working phase inflowing fluid from outside directly to filter chamber 30.

In external cylindrical surface 21 of piston unit 17 deaerating hole 36 is situated and in internal cylindrical surface 28 deaerating notch 37 is situated. They are placed so, that they are reciprocally in line, and by means of them the chimney 38 of cover unit 25 and deaerating valve 39 are connected, making possible, at second position, taking outside air collected in filter chamber 30.

Piston unit 17 together with control unit 9 are fastened to cover unit 25 by means of internal thread 27 mentioned above of cover unit 25 and by means of external thread 20 of piston unit 17. In cover unit 25 is situated cover valve 26, closing from below working chamber 22 and making possible during working phase to pour fluid from filter chamber 30 and during the phase of pumping out air to pump out it from filter chamber 30 into working chamber 22 and counteracts during this phase against air return from working chamber 22 into filter chamber 30. Cover unit 25 with piston unit 17 and control unit 9 assembled, is installed on filter container 29 by means of snap fasteners 31.

### EXAMPLE 2

Construction analogous as in example 1. Differences are of such kind that instead of controlling element 1 in form of a plate, in its place is fastened controlling element 1 in form of a sleeve 32. The sleeve 32 is fastened by means of fastening hole 34 to movable part 16 of the control unit 9. Analogically as in the example 1, in the sleeve 32 is situated outflow hole 2, through which fluid leaves filter chamber 30 during working phase, inflow hole 6, through which fluid flows out to filter chamber 30 during working phase, control valve 3 with the hole of control socket 4, which separate inflow conduits from working chamber 22 and through which, in the third position—air is pumped out from filter chamber 30 part 7 without passage, which, during the phase of pumping out air, closes inflow terminal 11, counteracting the inflow of fluid into filter chamber 30 during this phase, inflow fragment 5 without passage, and outflow fragment 8 without passage, which are in line respectively with inflow terminal 11 and outflow terminal 12 making possible disassembling the control unit 9 from piston unit 17 and counteract the outflow of fluid from inflow conduits. The remainder is analogous as in the example 1.

### EXAMPLE 3

Construction analogous as in example 1. Differences are of such kind that instead of controlling element 1 in form of a plate, in its place is fastened, in the same way, controlling element 1 in form of a cone 33. The cone 33 is fastened by means of fastening hole 34 to movable part 16 of the control unit 9. Analogically as in the example 1, in the cone 33 is situated outflow hole. 2, through which fluid leaves filter chamber 30 during working phase, inflow hole 6, through which fluid flows out to filter chamber 30 during working phase, control valve 3 with the hole of control socket 4, which separate inflow conduits from working chamber 22 and through which, in the third position—air is pumped out from filter chamber 30, part 7 without passage, which during the phase of pumping out air closes inflow terminal 11 counteracting an inflow of fluid into filter chamber 30 during this phase, inflow fragment 5 without passage, and outflow fragment 8 without passage, which are in line respectively with inflow terminal 11 and outflow terminal 12, making possible disassembling of control unit 9 from piston unit 17 and counteract outflowing of fluid from inflow conduits. The remainder is analogous as in the example 1.

### EXAMPLE 4

Control unit 9 may also be separated from piston unit 17 and fastened in the cover 40. Then, after having set up the first, second, or third positions of control unit 9 towards controlling element 1, control unit 9 is not submitted to a motion together with the motion of piston unit 17. Working chamber 60 is connected with controlling element 1 of control unit 9 by intermedairy of the connector 43 and control valve 3 may be situated either in controlling element 1 or between it and working chamber 60.

Alternative construction is composed therefore of control unit 9 identical as in case of example 1 with identical controlling element 1, of the cover 40 bottom 41, filter container 29, nut 42, connector 43, and of piston 44. On the filter container 29 the bottom 41 is fastened. In upper surface 45 of bottom 41 is situated outflow chimney 47 through which fluid is pressed out from filter chamber 30, inflow chimney 46 through which fluid flows into filter chamber 30, lower socket 50 of the engine with the rotor 51 making possible pumping in and filtering fluid during working phase, cavity 48, into which enters the connector 43 connector hole 49, into which enters pump valve 53 being the component part of the connector 43. In lower surface 54 of the bottom 41 is situated rotor chamber 55, into which fluid is sucked up from filter chamber 30 during working phase. On the bottom 41 is fastened the cover 40. In lower surface 56 of the cover 40 is situated upper socket 57 of the engine, which corresponds to lower socket 50 of the engine, which, after placing the engine, are potted with a resin, upper part of the pump 58 in which enters lower part of the pump 59 of the connector 43 and which together close from both sides working chamber 60. In upper surface 61 of the cover 40 are situated upper socket 62 of control valve, into which is assembled by rotary motion the control unit 9, upper closure 63 of upper part of the pump 58 with upper hole 64 on piston 44. In upper socket 62 are situated upper inflow 65 of the cover 40 which is in line with inflow chimney 46 of the bottom 41, upper outflow 66 of the cover 40, which is in line with outflow chimney 47 of the bottom 41, valve inlet 67 of the cover 40, which is connected with valve protrusion 68 of the connector 43. The protrusion of valve 68 in a connector 43 conducts by means of inflow 69 situated in the connector 43 to working chamber 60 closed from below by pump valve 53 of lower part of the pump 59 of the connector 43. In upper socket 62 of cover 40 control unit 9 is installed. The construction of control unit is identical as in case of the example 1. The complete system after assembling the cover 40, together with all components, of bottom 41, together with all components, is screwed with filter container 29 by means of the nut 42.

1. External filter composed of a filter container, a filtering packs, a cover unit, an engine unit, together with a rotor and a working chamber with a piston unit and a non-return valve, characterised in that between the working chamber /22/with the piston unit /17/and the inflow conduits of fluid circulation is situated durably separately fastened, preferably rotationally, the control unit /9/with the controlling element /1/ assembled movably towards the control unit /9/, having a fluid inflow hole /6/, a fluid outflow hole /2/and a hole of pumping cycle /4/, and, at the same time, reciprocal position of fluid inflow hole /6/and fluid outflow hole /2/ corresponds to the inflow terminal /11/and outflow terminal /12/for fluid distribution situated in the control unit /9/and between working chamber /22/and hole of pumping cycle /4/the control valve /3/is situated.

2. The filter according to claim 1, characterised in that its control valve /3/is situated in the hole of pumping cycle /4/.

3. The filter according to claim 1, characterised in that its control unit /9/is assembled rotationally in the piston unit /17/.

4. The filter according to claim 1, characterised in that its control unit /9/is assembled rotationally in the cover unit /25/.

5. The filter according to claim 1, characterised in that its controlling element /1/ is assembled in the control unit /9/rotationally.

6. The filter according to claim 5, characterised in that its controlling element /1/has a fastening hole /34/.

7. The filter according to claim 1, characterised in that its controlling element /1/is assembled in the control unit /9/in the way making possible its shifting.

8. The filter according to claim 1, characterised in that its control unit /9/is equipped with a hand grip /10/.

9. The filter according to claim 1, characterised in that its control unit /9/ has external groove /14/in its external surface /13/.

10. The filter according to claim 1, characterised in that its control unit /9/ has external notch /15/in its external surface /13/and piston unit /17/has internal protrusion /2/in its internal surface /24/.

11. The filter according to claim 1, characterised in that the piston unit /17/has a handle /18/.

12. The filter according to claim 1, characterised in that the piston unit /17/has external thread /20/in its external cylindrical surface /21/and cover unit /25/has internal thread /27/in its cylindrical surface /28/.

13. The filter according to claim 1, characterised in that its controlling element /1/has the shape of a sleeve.

14. The filter according to claim 1, characterised in that its controlling element /1/has the shape of a cone.

15. The filter according to claim 1, characterised in that its controlling element /1/has the shape of a plate.

16. The filter according to claim 1, characterised in that the piston unit /17/has deaerating valve /39/with deaerating notch /37/.

17. The filter according to claim 4, characterised in that between the control unit /9/ and upper part of the pump /58/the connector /43 is assembled.

18. The filter according to claim 1, characterised in that in the cover unit /25/ deaerating chimney /38/is situated.
